(19) United States
(12) Patent Application Publication
(10) Pub. No.: US 2018/0252364 A1
(43) Pub. Date: Sep. 6, 2018

(54) FLUID SUPPLY DEVICE

(71) Applicant: Koyo Thermo Systems Co., Ltd., Nara (JP)

(72) Inventors: Akihito YAMAMOTO, Tenri-shi (JP); Yasuhiro SASAKI, Tenri-shi (JP)

(73) Assignee: Koyo Thermo Systems Co., Ltd., Nara (JP)

(21) Appl. No.: 15/760,039

(22) PCT Filed: May 2, 2016
(86) PCT No.: PCT/JP2016/063571

§ 371 Date: Mar. 14, 2018

(30) Foreign Application Priority Data
Mar. 15, 2016 (JP) 2016-050487

(51) Int. Cl. F17C 1/06; B29C 70/54

(52) U.S. Cl. CPC F17C 1/06; B29C 70/32; B29C 70/54

(57) ABSTRACT

Provided is a fluid supply device capable of reducing loads to be applied to pipings while increasing tolerable rotation amounts of respective nozzles around a predetermined rotation axis. A fluid supply device 5 includes first pipings 31A to 31L connected to nozzles 11A to 11C and 12F to 12J, a rotary support part 10 supporting the nozzles 11A to 11C and 12F to 12J and the first pipings 31A to 31L, second flexible pipings 33A to 33L, and a linear guide 15. One end portions 33a of the second flexible pipings 33A to 33L are configured to rotate around a rotation axis L1 in conjunction with the respective first pipings 31A to 31L. A movable guide portion 51 of the linear guide 15 is configured to be linearly displaceable along with deforming movements of the respective second flexible pipings 33A to 33L caused by rotations of the respective first pipings 31A to 31L.

### TECHNICAL FIELD

The present invention relates to a fluid supply device.

### BACKGROUND ART

In some cases of manufacturing industrial products, a nozzle for jetting or suctioning a fluid is used (for example, refer to Patent Application Documents 1 to 3). The work holding device described in Patent Application Document 1 is configured to jet a cleaning coolant from an attachment nozzle (360) toward a crankcase (W) as a work.

The part mounting head described in Patent Application Document 2 is configured to suction a part (120) by using suction nozzles (112). The painting robot (1) described in Patent Application Document 3 includes a bending-deformable supply line (10) arranged between a robot element (3) and a robot element (6). This supply line (10) has a U-shaped loop (12). Accordingly, the painting robot is configured so that while the robot (1) turns, the supply line (10) can be displaced in an axial direction of the supply line (10).

### CITATION LIST

### Patent Application Documents

Patent Application Document 1: Japanese Unexamined Patent Application Publication No. H08-294836

Patent Application Document 2: Japanese Unexamined Patent Application Publication No. 2006-261345

Patent Application Document 3: Japanese Translation of PCT International Application Publication No. 2012-519081

### SUMMARY OF THE INVENTION

### Problem to be Solved by the Invention

In some cases of manufacturing a storage tank by using a resin material, a resin is molten onto a surface of a base material of the tank, and then the resin is cured to integrate the base material and the resin. In this case, in order to extinguish bubbles generated from the molten resin, it is possible that high-temperature compressed air may be jetted to a bubble generating portion. As a possible configuration to jet compressed air, a plurality of nozzles to jet compressed air are provided, and these nozzles rotate around a predetermined rotation axis. With this configuration, the positions of the nozzles with respect to the tank are changeable. Therefore, each nozzle can be disposed at an optimum position to extinguish bubbles on the tank surface.

With this configuration, a plurality of pipings to supply compressed air to the respective nozzles are needed. In addition, since the nozzles are configured to rotate around a rotation axis, a piping layout tolerating the rotational movements of the nozzles is needed. In particular, if a piping twists according to rotational movement of the nozzle, the piping is subjected to a great load.

However, the configurations described in Patent Application Documents 1 to 3 do not particularly disclose a configuration to increase tolerances of rotational movements of the respective nozzles in the configuration in which a plurality of pipings are connected to a plurality of nozzles.

In view of the above-described circumstances, an object of the present invention is to provide a fluid supply device capable of reducing loads to be applied to pipings while increasing tolerable rotation amounts of the respective nozzles around a rotation axis.

### Means for Solving the Problem

(1) In order to solve the above-described problem, a fluid supply device according to an aspect of the present invention includes a plurality of nozzles, a plurality of first pipings connected to the plurality of nozzles, a rotary support part to support the respective nozzles and the respective first pipings rotatably around a predetermined rotation axis, a plurality of second flexible pipings configured to have flexibility, each including one end portion configured rotatably around the rotation axis in conjunction with a corresponding one of the plurality of first pipings, and configured to be connected to a corresponding one of the plurality of first pipings, and a linear guide including a movable guide portion supporting the other end portions of the respective second flexible pipings, and linearly displaceable according to deforming movements of the respective second flexible pipings caused by rotations of the respective first pipings.

With this configuration, along with rotational movement of each nozzle around the rotation axis, one end portion of the second flexible piping rotates around the rotation axis. By this movement, the other end portion of the second flexible piping is subjected to an attraction force toward one end portion side of this second flexible piping or a force in a direction away from the one end portion. As a result, the second flexible piping bends and deforms so that its length in the rotation axis direction becomes shorter or longer. Then, along with this deformation of the second flexible piping, the movable guide portion of the linear guide linearly moves. With this configuration, application of excessive loads between one end portions and the other end portions of the second flexible pipings rotating relative to each other around the rotation axis according to rotational movements of the respective nozzles can be suppressed. In addition, a plurality of second flexible pipings are provided, thus, each second flexible piping can be made thinner. Accordingly, the flexibility of each second flexible piping can be increased. As a result, in each second flexible piping, a tolerance of an amount of relative rotation between one end portion and the other end portion around the rotation axis can be increased. Accordingly, in the fluid supply device, loads to be applied to the pipings can be reduced, and the tolerable rotation amounts of the respective nozzles around the rotation axis can be increased. Thus, a fluid supply device capable of reducing loads to be applied to pipings while increasing tolerable rotation amounts of the respective nozzles around the rotation axis can be realized.

(2) Preferably, the fluid supply device further includes a plurality of third flexible pipings configured to have flexibility, each including one end portion connected to the other end portion of a corresponding one of the plurality of second flexible pipings and linearly displaceable integrally with the other end portion, and a support portion to support the other end portions of the plurality of third flexible pipings.

With this configuration, along with linear displacement of the movable guide portion, one end portion of the third flexible piping is displaced relative to the other end portion of the third flexible piping in a direction parallel to the rotation axis. Such a displacement can reduce a load to be caused by bending deformation of the third flexible piping. Therefore, loads on the pipings in the fluid supply device can be made smaller.

(3) Preferably, the support portion is disposed below the rotary support part, and at least a part of each third flexible piping extends in a curved form toward a lower side of the rotary support part.

With this configuration, the support portion is disposed in a space below the rotary support part. Thus, the support portion and at least parts of the third flexible pipings can be disposed in a space produced by provision of the rotary support part. As a result, by effective utilization of the space, the fluid supply device can be made more compact.

(4) Preferably, at least one of one end portion and the other end portion of the second flexible piping is connected to a corresponding one of the first pipings and a corresponding one of the third flexible pipings via a rotary joint, and the rotary joint is configured to tolerate relative rotation of the second flexible piping and the corresponding first piping and third flexible piping.

With this configuration, in the second flexible piping provided with the rotary joint, a torsional movement can be greatly prevented from occurring between one end portion and the other end portion. Accordingly, a tolerance of relative rotation between one end portion and the other end portion of the second flexible piping around the rotation axis can be increased. That is, tolerable rotation amounts of the respective nozzles around the rotation axis can be increased. In addition, loads to be applied to the respective second flexible pipings can be reduced.

(5) Preferably, the fluid supply device further includes a support mechanism to support the rotary support part, and a position adjusting mechanism capable of adjusting a position of the support mechanism to adjust a position of the rotary support part.

With this configuration, the rotary support part subjected to a great load by supporting the plurality of nozzles and the plurality of first pipings is supported by the support mechanism. Accordingly, the rotary support part can be more reliably prevented from deviating from an original position due to rotational movement. By the position adjusting mechanism provided, the position of the rotary support part with respect to a housing chamber, etc., in which the rotary support part is installed, can be adjusted.

### Effects of the Invention

According to the present invention, a fluid supply device capable of reducing loads to be applied to pipings while increasing tolerable rotation amounts of respective nozzles around the rotation axis can be realized.

### BRIEF DESCRIPTION OF THE DRAWINGS

FIG. 1 is a schematic side view of heat treatment apparatus according to an embodiment of the present invention, omitting illustration of a part of members and showing a part of members in section.

FIG. 2 is an enlarged view of a main portion around a housing chamber of the heat treatment apparatus in FIG. 1, showing a state of manufacturing a thick tank.

FIG. 3 is a view showing the periphery of the main portion of the housing chamber of the heat treatment apparatus, showing a state of manufacturing a thin tank.

FIG. 4 is a side view showing a part of the housing chamber of the heat treatment apparatus and the outside of the housing chamber, omitting illustration of apart of members and showing a part of members in section.

FIG. 5 is a further enlarged view of a part of FIG. 4.

FIG. 6 is a sectional view taken along line VI-VI in FIG. 5, omitting illustration of members at a back side of the section.

FIG. 7 is a plan view showing a configuration of a main portion outside the housing chamber, omitting illustration of a part of members.

FIG. 8 is a front view showing the main portion outside the housing chamber, omitting illustration of apart of members.

FIG. 9 is a sectional view taken along line IX-IX in FIG. 5.

FIG. 10 is a schematic side view of a main portion to describe operation of the heat treatment apparatus, showing transition between a state of manufacturing a thick tank and a state of manufacturing a thin tank.

FIG. 11 is a schematic plan view of the main portion to describe operation of the heat treatment apparatus, showing transition between a state of manufacturing a thick tank and a state of manufacturing a thin tank.

FIG. 12 is a schematic side view of a main portion to describe a modification of the present invention.

FIG. 13 is a schematic side view of a main portion to describe another modification of the present invention.

### MODE FOR CARRYING OUT THE INVENTION

Hereinafter, an embodiment of the present invention is described with reference to the drawings. The present invention can be widely applied as a fluid supply device.

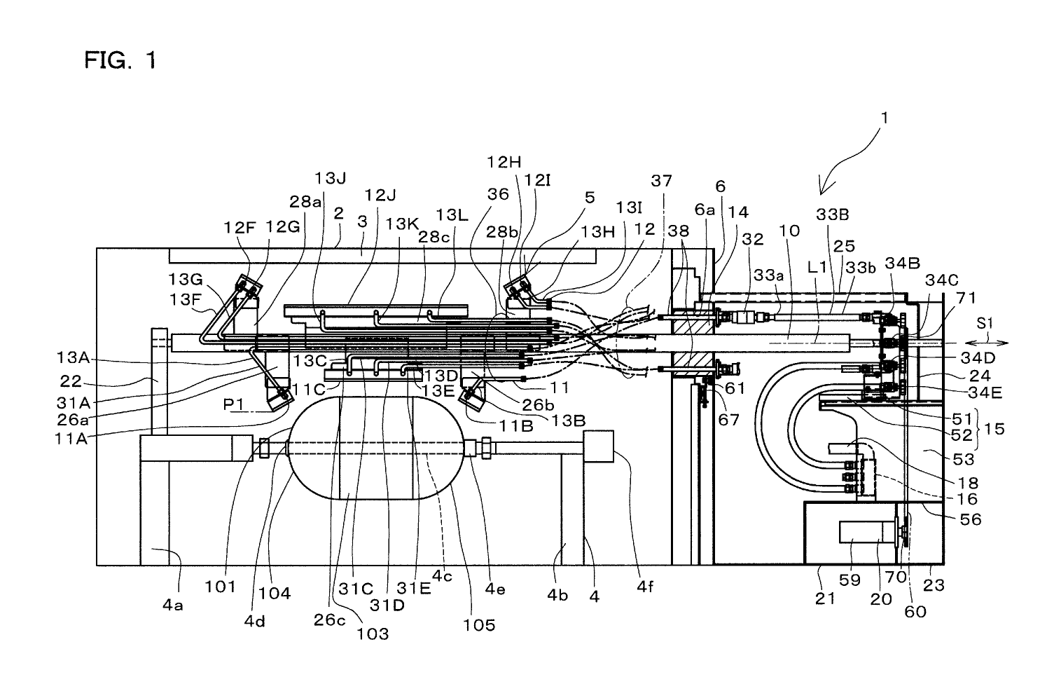

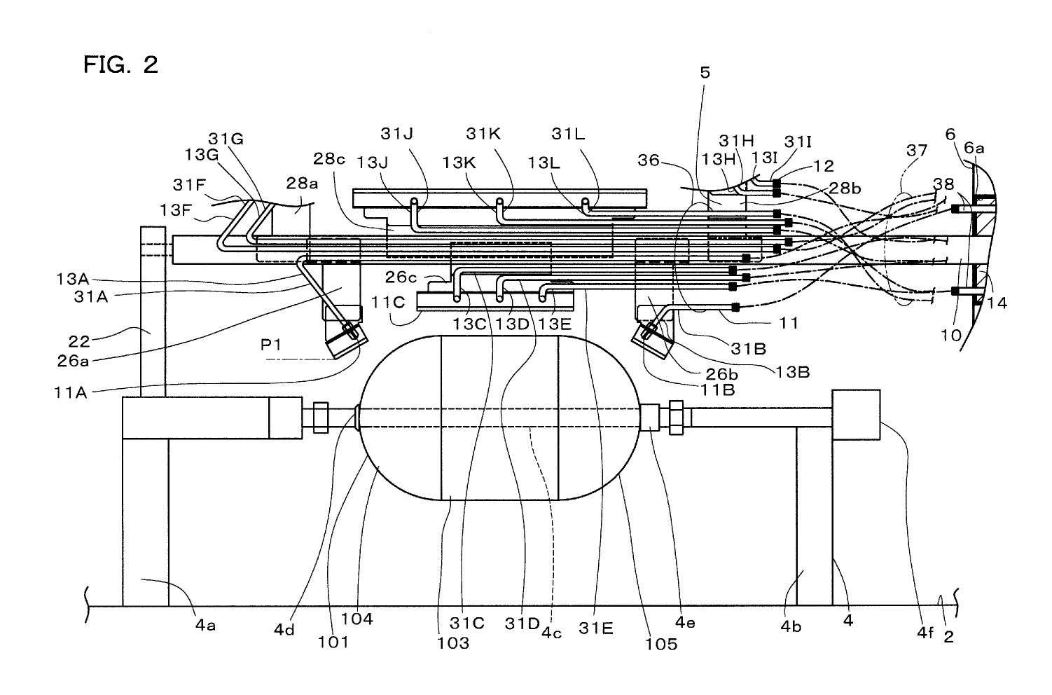

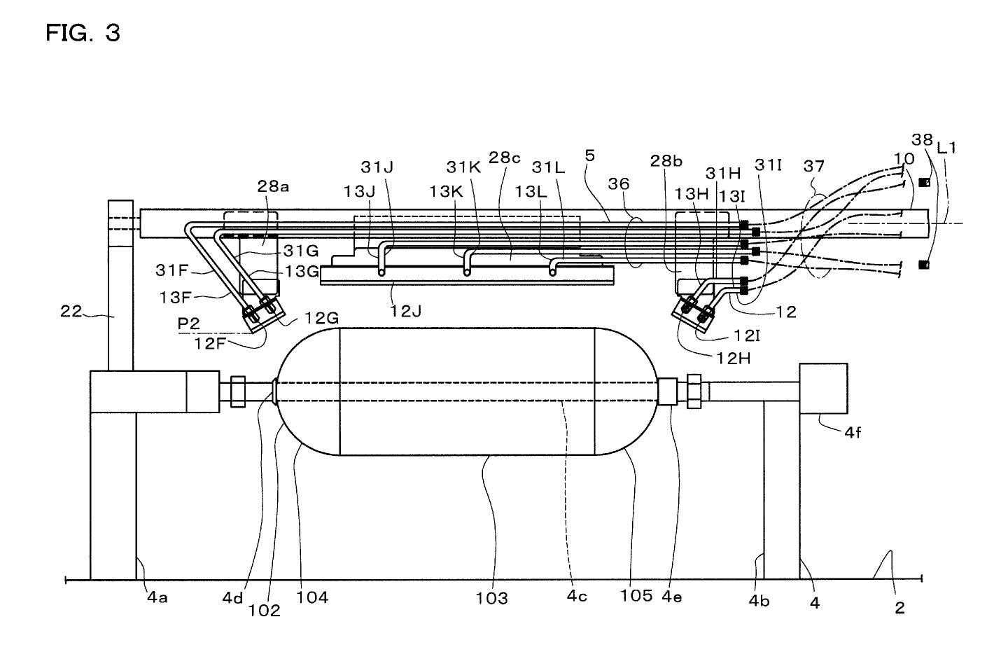

FIG. 1 is a schematic side view of heat treatment apparatus 1 according to an embodiment of the present invention, omitting illustration of a part of members and showing a part of members in section. FIG. 2 is an enlarged view of a main portion around a housing chamber 2 of the heat treatment apparatus 1 in FIG. 1, showing a state of manufacturing a thick tank 101. FIG. 3 is a view showing the periphery of the main portion of the housing chamber 2 of the heat treatment apparatus 1, showing a state of manufacturing a thin tank 102.

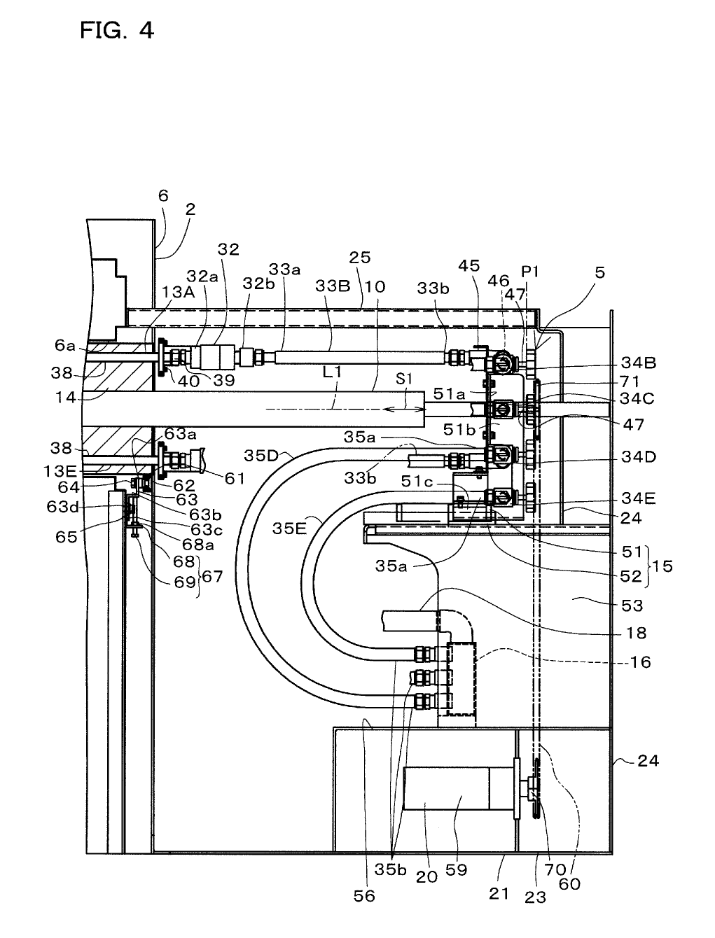

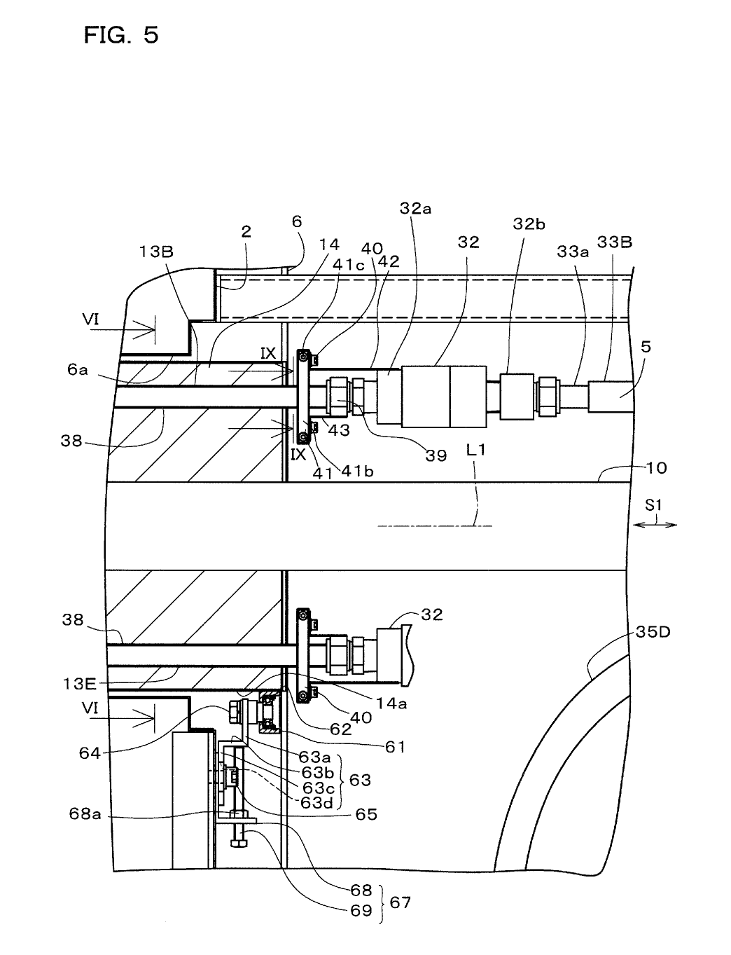

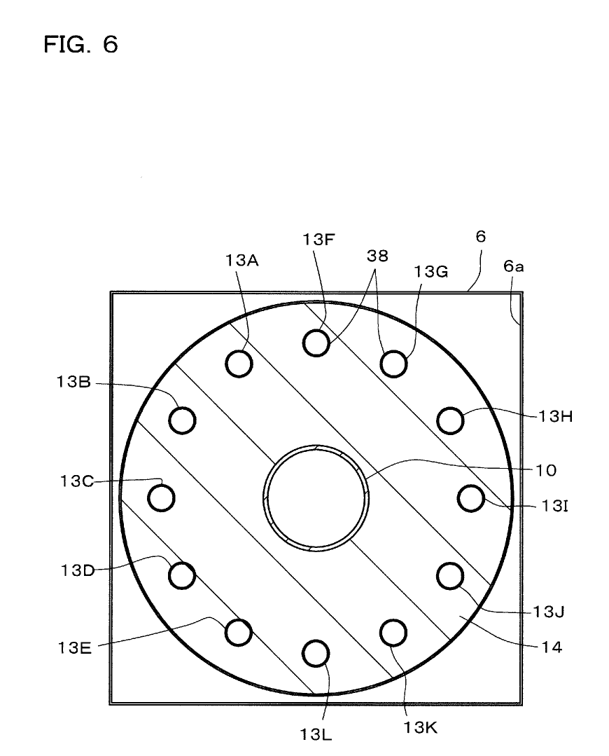

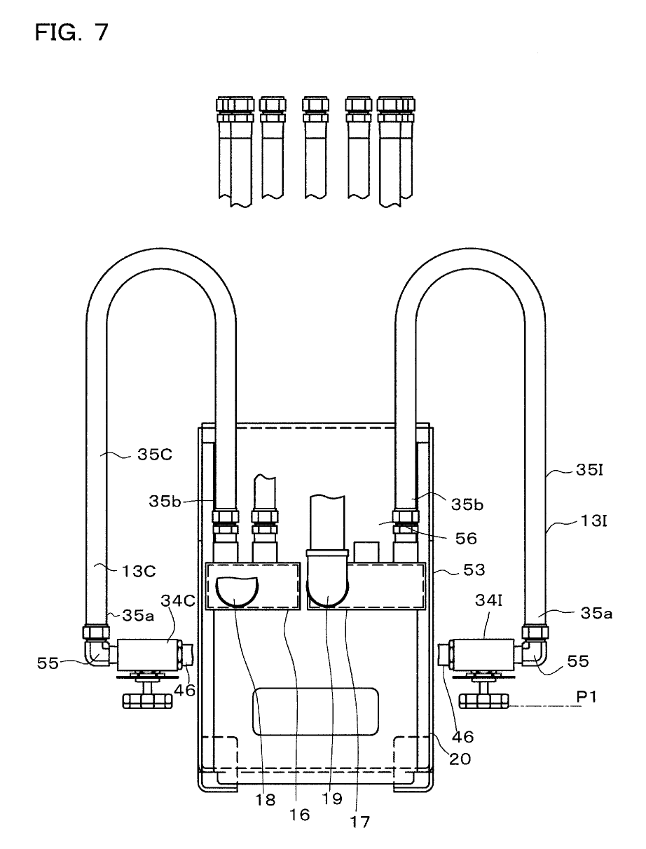

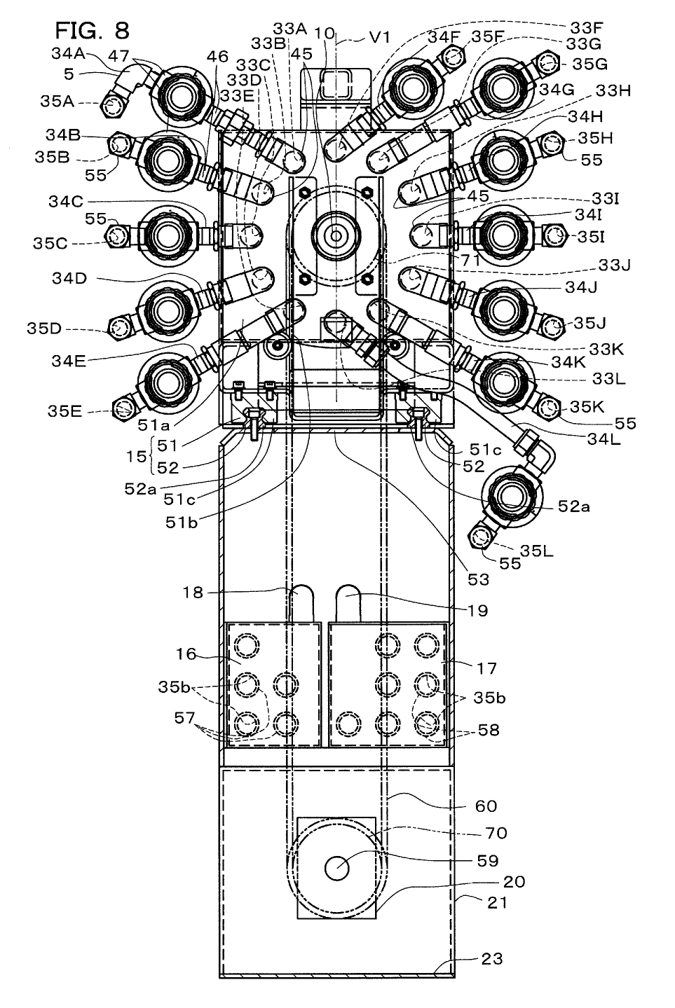

FIG. 4 is a side view showing a part of the housing chamber 2 of the heat treatment apparatus 1 and the outside of the housing chamber 2, omitting illustration of a part of members and showing a part of members in section. FIG. 5 is a further enlarged view of a part of FIG. 4. FIG. 6 is a sectional view taken along line VI-VI in FIG. 5, omitting illustration of members at a back side of the section. FIG. 7 is a plan view showing a configuration of a main portion outside the housing chamber 2, omitting illustration of a part of members. FIG. 8 is a front view showing the main portion outside the housing chamber 2, omitting illustration of a part of members.

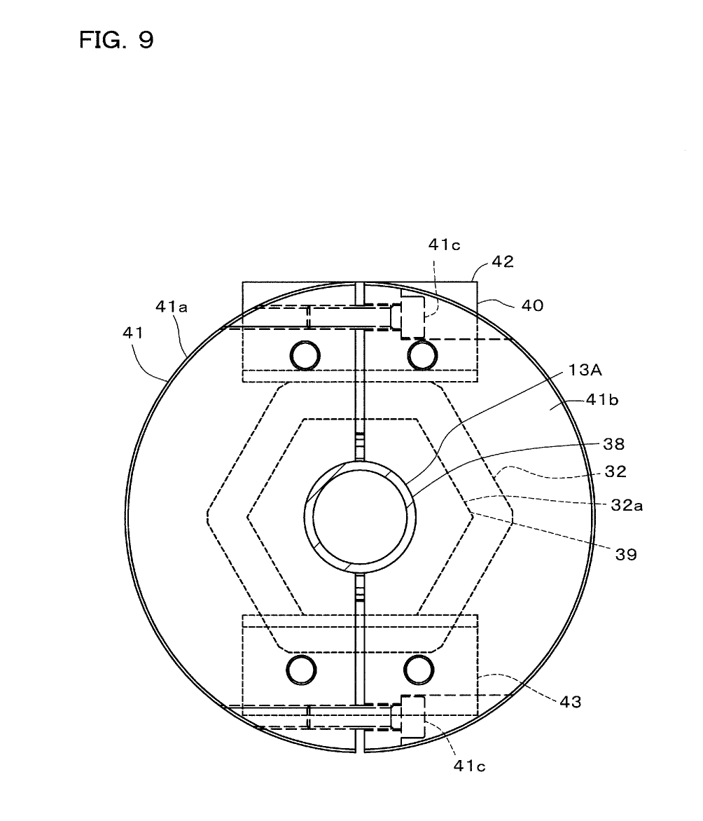

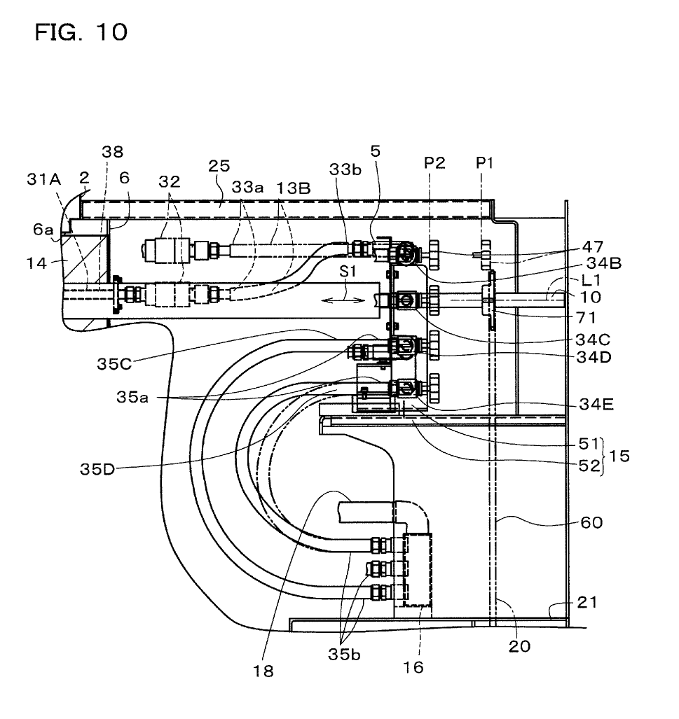

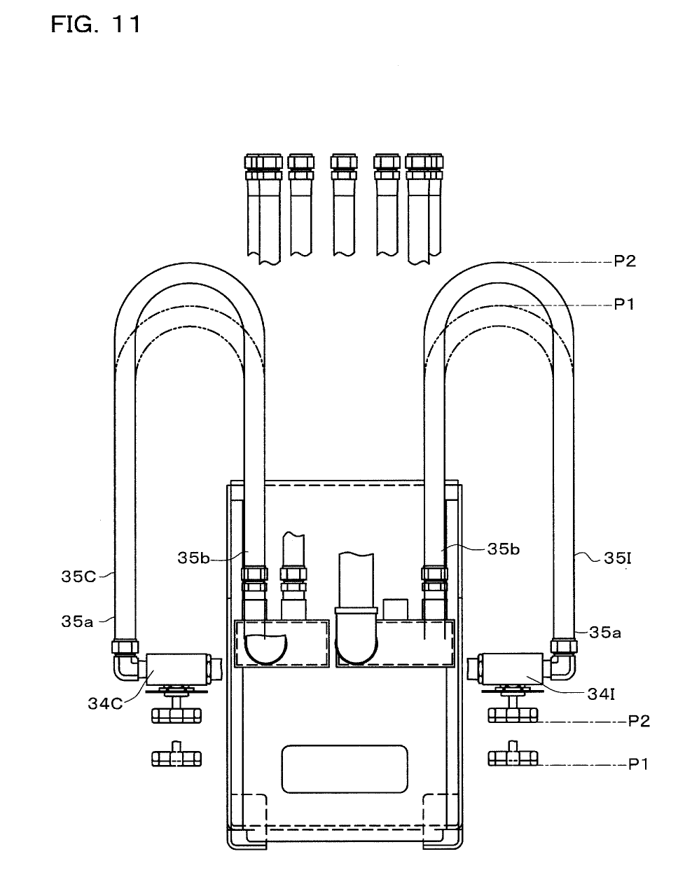

FIG. 9 is a sectional view taken along line IX-IX in FIG. 5. FIG. 10 is a schematic side view of a main portion to describe operation of the heat treatment apparatus 1, showing transition between a state of manufacturing the thick tank 101 and a state of manufacturing the thin tank 102. FIG. 11 is a schematic plan view of the main portion to describe operation of the heat treatment apparatus 1, showing transition between a state of manufacturing the thick tank 101 and a state of manufacturing the thin tank 102.

Referring to FIG. 1 to FIG. 3, the heat treatment apparatus 1 is provided to apply heat treatment to the thick tank 101 or the thin tank 102. At the time of manufacturing the tank 101 or 102, reinforced fibers impregnated with a resin are wound around a surface of a tank base material formed by using a hard resin, etc. in advance. Then, the resin in the reinforced fibers is molten by heating the reinforced fibers by the heat treatment apparatus 1, and thereafter, the resin is cured by cooling treatment to form the thick tank 101 or the thin tank 102. As a resin with which the reinforced fibers are impregnated, an epoxy resin can be used by way of example.

Thus, the heat treatment apparatus 1 is used to integrate the resin in the reinforced fibers with the surface of the tank base material. When the resin with which the reinforced fibers are impregnated is molten on the surface of the tank base material, bubbles are generated from this resin. The heat treatment apparatus 1 in the present embodiment is configured to jet a compressed gas such as compressed air to the bubbles. Accordingly, the heat treatment apparatus 1 is configured to extinguish the bubbles.

In the present embodiment, the heat treatment apparatus 1 is configured to be capable of forming the thick tank 101 and the thin tank 102 as a plurality of kinds of tanks with different shapes different in size and length, etc. In the present embodiment, respective cases of manufacturing the thick tank 101 and the thin tank 102 are described by way of example. An entire length of the thick tank 101 is set to be shorter than an entire length of the thin tank 102. A diameter of the thick tank 101 is set to be larger than a diameter of the thin tank 102.

Each of the tanks 101 and 102 has a cylindrical intermediate portion 103 and end portions 104 and 105 formed to be semispherical at both end portions of the intermediate portion 103. In the respective end portions 104 and 105 of each of the tanks 101 and 102, through hole portions are formed.

The heat treatment apparatus 1 includes a housing chamber 2, a heater 3, a tank support device 4, and a fluid supply device 5.

The housing chamber 2 is provided to house the tank 101 or 102. The housing chamber 2 is formed to have, for example, a hollow box shape. Carrying of the tank 101 or 102 into the housing chamber 2 and carrying out of the tank 101 or 102 from the housing chamber 2 are performed by using a carrying device not shown.

In one side wall 6 of the housing chamber 2, a through hole portion 6a is formed. This through hole portion 6a is provided to allow the fluid supply device 5 to pass through. The heater 3 is disposed inside the housing chamber 2.

The heater 3 is provided to melt a resin material to be integrated with the surface of the base material of the tank 101 or 102. The heater 3 includes a heating source such as a gas burner or an electric heater, and is configured to raise an atmospheric temperature inside the housing chamber 2 to, for example, several hundreds of degrees C. The tank 101 or 102 to be heated by the heater 3 is supported inside the housing chamber 2 by the tank support device 4.

The tank support device 4 is configured to support the tank 101 or 102 so that the tank 101 or 102 is oriented horizontally, that is, the central axis of the tank 101 or 102 is directed horizontally. The tank support device 4 is configured to make the tank 101 or 102 rotatable around the central axis of the tank 101 or 102, respectively.

The tank support device 4 includes a pair of columnar supports 4a and 4b, a support shaft 4c supported by the pair of columnar supports 4a and 4b, a pair of stoppers 4d and 4e, and a tank rotation mechanism 4f.

The pair of columnar supports 4a and 4b respectively extend upward from a bottom wall of the housing chamber 2. The support shaft 4c extends in the horizontal direction. At both end portions of the support shaft 4c, the pair of columnar supports 4a and 4b are disposed. The support shaft 4c is supported by the columnar supports 4a and 4b via bearings, etc., not shown, and is rotatable around the central axis of the support shaft 4c. The support shaft 4c supports the tank 101 or 102 by penetrating through the tank 101 or 102. To the support shaft 4c, the pair of stoppers 4d and 4e are attached.

The pair of stoppers 4d and 4e are provided to position the tank 101 or 102 in the axial direction with respect to the support shaft 4c. The pair of stoppers 4d and 4e are disposed to sandwich the tank 101 or 102. For example, one stopper 4d is fixed to the support shaft 4c. The other stopper 4e is configured to be slidable in the axial direction of the support shaft 4c with respect to the support shaft 4c. According to the configuration with regard to the tank support device 4, the other stopper 4e can be disposed at a position corresponding to each of the tanks 101 and 102 that are a plurality of kinds of tanks with different entire lengths.

In a state where the tank 101 or 102 is supported, when the tank rotation mechanism 4f operates, the tank 101 or 102 rotates around the support shaft 4c. The tank rotation mechanism 4f includes a drive source such as an electric motor, and is configured to be capable of rotating the support shaft 4c at a predetermined rotation speed. A gas from the fluid supply device 5 is supplied to the surface of the tank 101 or 102 being rotated by the tank rotation mechanism 4f.

Referring to FIG. 1 to FIG. 8, the fluid supply device 5 is provided to supply a compressed gas such as compressed air to the surface of the tank 101 or 102. This compressed gas is made to blow bubbles generated on the surface of the tank 101 or 102. Accordingly, the bubbles are extinguished. The fluid supply device 5 is configured to transfer a compressed gas supplied from the outside of the housing chamber 2 to the inside of the housing chamber 2, and further jet the compressed gas to the surface of the corresponding tank 101 or 102. As the compressed gas, compressed air or compressed inert gas such as compressed nitrogen gas can be used by way of example. In the present embodiment, the fluid supply device 5 is configured to supply a compressed gas at a high temperature of approximately 200° C.

The fluid supply device 5 includes a rotary support part 10, a nozzle unit 11 for a thick tank and a nozzle unit 12 for a thin tank as a plurality of kinds of nozzle units, a plurality of pipelines 13A to 13L, a side wall flange portion 14, a linear guide 15, chambers 16 and 17, gas supply pipes 18 and 19, a rotation mechanism 20 to drive and rotate the rotary support part 10, amount 21, a support mechanism 61, and a position adjusting mechanism 67.

The rotary support part 10 is provided as a main shaft to support the nozzle unit 11 for a thick tank, the nozzle unit 12 for a thin tank, and first pipings 31A to 31L described below of the pipelines 13A to 13L integrally rotatably around a rotation axis L1 as the central axis of the rotary support part 10. In the present embodiment, the rotary support part 10 is rotatable up to 240 degrees around the rotation axis L1 from a predetermined reference position.

The rotary support part 10 extends in the horizontal direction, and in the present embodiment, is arranged parallel to the support shaft 4c supporting the tank 101 or 102. The rotary support part 10 extends from the inside of the housing chamber 2 to the outside of the housing chamber 2 through the through hole portion 6a of the side wall 6. In the rotary support part 10, one end portion disposed inside the housing chamber 2 is supported by a columnar support 22. This columnar support 22 is provided in the housing chamber 2, and supports one end portion of the rotary support part 10 rotatably around the rotation axis L1 via a bearing not shown. The other end portion of the rotary support part 10 is supported by a columnar support 24 described below of the mount 21. This columnar support 24 supports the other end portion of the rotary support part 10 rotatably around the rotation axis L1 via a bearing not shown.

The mount 21 is provided to support the rotary support part 10, the linear guide 15, the chambers 16 and 17, and the main rotation mechanism 20, etc.

The mount 21 has a base portion 23, the columnar support 24, a beam portion 25, a support member 53, and a seating portion 56.

The base portion 23 is a portion arranged horizontally parallel to the bottom wall of the housing chamber 2, and constitutes a foundation portion of the mount 21. From the base portion 23, the columnar support 24 extends upward. The columnar support 24 extends upward from, for example, one end portion of the base portion 23 in an axial direction S1 of the rotary support part 10, and is spaced from the side wall 6 of the housing chamber 2 in the axial direction S1. Hereinafter, the axial direction S1 of the rotary support part 10 is simply referred to as “axial direction S1.”

Between the columnar support 24 and the side wall 6, a portion of the fluid supply device 5 exposed to the outside of the housing chamber 2 is disposed. This disposition can make more compact the fluid supply device 5. At an upper end portion of the columnar support 24, the beam portion 25 is disposed. The beam portion 25 extends parallel to the axial direction S1. One end portion of the beam portion 25 is fixed to the columnar support 24. Other end portion of the beam portion 25 is fixed to the side wall 6 of the housing chamber 2. At the rotary support part 10 supported by the mount 21, the nozzle unit 11 for a thick tank and the nozzle unit 12 for a thin tank are installed.

The nozzle unit 11 for a thick tank is provided to jet a compressed gas to the thick tank 101. The nozzle unit 11 for a thick tank is disposed around the rotary support part 10. In the present embodiment, the nozzle unit 11 for a thick tank is configured to be capable of jetting a compressed gas toward the thick tank 101 when the rotary support part 10 and the nozzle unit 11 for a thick tank are at a first position P1 as a predetermined rotational position. Hereinafter, description is given based on a case where the respective components such as the rotary support part 10 are disposed at the first position P1 unless otherwise specified.

The nozzle unit 11 for a thick tank includes end portion nozzles 11A and 11B and an intermediate nozzle 11C as a plurality of nozzles.

The end portion nozzles 11A and 11B are provided to jet a compressed gas toward the end portions 104 and 105 of the thick tank 101. Outlets of the end portion nozzles 11A and 11B are disposed to face the corresponding end portions 104 and 105 of the thick tank 101 when the nozzles are at the first position P1. These end portion nozzles 11A and 11B are supported by the rotary support part 10 via corresponding brackets 26a and 26b. The intermediate nozzle 11C is disposed between the end portion nozzles 11A and 11B.

The intermediate nozzle 11C is provided to jet a compressed gas toward the intermediate portion 103 of the thick tank 101. An outlet of the intermediate nozzle 11C extends parallel to the axial direction S1, and is disposed to face the intermediate portion 103 of the thick tank 101 when the nozzle is at the first position P1. This intermediate nozzle 11C is supported by the rotary support part 10 via a bracket 26c.

At a position around the rotation axis L1 deviating from the nozzle unit 11 for a thick tank configured as described above, the nozzle unit 12 for a thin tank is disposed. FIG. 2 omits illustration of a part of the nozzle unit 12 for a thin tank, and FIG. 3 omits illustration of the nozzle unit 11 for a thick tank.

Referring to FIG. 3, the nozzle unit 12 for a thin tank is provided to jet a compressed gas to the thin tank 102. The nozzle unit 12 for a thin tank is disposed around the rotary support part 10. The nozzle unit 12 for a thin tank is configured to be capable of jetting a compressed gas toward the thin tank 102 when the rotary support part 10 and the nozzle unit 12 for a thin tank are at a second position P2 as a predetermined rotational position.

The nozzle unit 12 for a thin tank includes end portion nozzles 12F, 12G, 12H, and 12I and an intermediate nozzle 12J as a plurality of nozzles.

The end portion nozzles 12F and 12G are provided to jet a compressed gas toward the end portion 104 of the thin tank 102. The end portion nozzles 12H and 12I are provided to jet a compressed gas toward the end portion 105 of the thin tank 102. Outlets of the end portion nozzles 12F, 12G, 12H, and 12I are disposed to face the corresponding end portions 104 and 105 of the thin tank 102 when the nozzles are at the second position P2. These end portion nozzles 12F, 12G, 12H, and 12I are supported by the rotary support part 10 via corresponding brackets 28a and 28b. Between the end portion nozzles 12F and 12G and the end portion nozzles 12H and 12I, the intermediate nozzle 12J is disposed.

The intermediate nozzle 12J is provided to jet a compressed gas toward the intermediate portion 103 of the thin tank 102. An outlet of the intermediate nozzle 12J extends parallel to the axial direction S1, and is disposed to face the intermediate portion 103 of the thick tank 101 when the nozzle is at the second position P2. This intermediate nozzle 12J is supported by the rotary support part 10 via a bracket 28c.

Referring to FIG. 1 to FIG. 8, the nozzle unit 11 for a thick tank and the nozzle unit 12 for a thin tank, configured as described above, are connected to corresponding pipelines 13A to 13L.

In the present embodiment, the pipelines 13A to 13E are provided as pipelines to supply a compressed gas to the nozzles 11A to 11C of the nozzle unit 11 for a thick tank. The pipelines 13F to 13L are provided as pipelines to supply a compressed gas to the nozzles 12F to 12J of the nozzle unit 12 for a thin tank. Thus, in the present embodiment, a plurality (twelve in this embodiment) of pipelines are provided.

The pipelines 13A to 13L respectively include first pipings 31A to 31L, rotary joints 32, second flexible pipings 33A to 33L, folded-back pipings 34A to 34L, and third flexible pipings 35A to 35L.

In detail, the pipeline 13A includes a first piping 31A, a rotary joint 32, a second flexible piping 33A, a folded-back piping 34A, and a third flexible piping 35A. That is, the pipeline 13x (x here represents any alphabet of A to L) includes a first piping 31x, a rotary joint 32, a second flexible piping 33x, a folded-back piping 34x, and a third flexible piping 35x.

The respective first pipings 31A to 31L are disposed mainly inside the housing chamber 2. The respective first pipings 31A to 31L are configured to extend along the axial direction S1 as a whole. The first pipings 31A to 31L area group of pipings each of which is connected to any of the nozzles 11A, 11B, 11C, 12F, 12G, 12H, 12I and 12J of the nozzle units 11 and 12 for tanks.

In the present embodiment, the first pipings 13A to 13E are provided as pipings to be connected to the nozzle unit 11 for a thick tank. The first pipings 13F to 13L are provided as pipings to be connected to the nozzle unit 12 for a thin tank.

Each of the first pipings 31A to 31L has a first portion 36, a second portion 37, and a third portion 38.

The first portion 36 is provided as a portion to be directly connected to a corresponding one of the nozzles 11A to 11C and 12F to 12J. The first portion 36 is provided as a rigid metal piping not intended to deform.

In the present embodiment, one end portion of the first portion 36 of the first piping 31A is connected to the end portion nozzle 11A of the nozzle unit 11 for a thick tank. One end portion of the first portion 36 of the first piping 31B is connected to the end portion nozzle 11B of the nozzle unit 11 for a thick tank. One end portions of the first pipings 31C to 31E are respectively connected to the intermediate nozzle 11C of the nozzle unit 11 for a thick tank.

In the present embodiment, one end portions of the first portions 36 of the first pipings 31F and 31G are connected to the end portion nozzles 12F and 12G of the nozzle unit 12 for a thin tank. One end portions of the first portions 36 of the first pipings 31H and 311 are connected to the end portion nozzles 12H and 12I of the nozzle unit 12 for a thin tank. One end portions of the first pipings 31J to 31L are respectively connected to the intermediate nozzle 12J of the nozzle unit 12 for a thin tank.

The other end portions of the respective first pipings 31A to 31L are disposed around the rotary support part 10, and connected to the corresponding second portions 37.

The second portions 37 of the respective first pipings 31A to 31L are formed by using, for example, flexible pipes having flexibility. As flexible pipes in the present embodiment, flexible pipes such as stainless steel bellows hoses can be used by way of example. Each second portion 37 has flexibility, and is bending-deformable and torsionally deformable.

As a result, in each of the first pipings 31A to 31L, even if relative positions of the first portion 36 and the third portion 38 are not accurately set, reliable connection of the second portion 37 to these corresponding first portion 36 and third portion 38 is realized. Note that, each second portion 37 is not limited to the flexible pipe, but may be formed of a general rigid pipe not intended to be used for the purpose requiring deformability.

In each of the first pipings 31A to 31L, the second portion 37 connects the other end portion of the first portion 36 and one end portion of the corresponding third portion 38.

The third portions 38 of the respective first pipings 31A to 31L are formed of, in the present embodiment, rigid pipes similar to the pipes of the first portions 36. The respective third portions 38 extend parallel to the axial direction S1 across the inside and the outside of the housing chamber 2. In the present embodiment, these third portions 38 are disposed around the rotary support part 10 at even intervals in a circumferential direction of the rotary support part 10. In the present embodiment, the third portions 38 are disposed at pitches of 30 degrees in the circumferential direction of the rotary support part 10. Each third portion 38 is supported integrally rotatably with the rotary support part 10 via a side wall flange portion 14.

The side wall flange portion 14 is a member disposed so as to close the through hole portion 6a of the side all 6. The side wall flange portion 14 is configured by, for example, disposing a heat insulating material between a pair of annular metal plates, and is joined to the rotary support part 10 integrally rotatably. The side wall flange portion 14 is formed to have a substantially circular shape.

In each of the first pipings 31A to 31L, the third portion 38 is connected to one end portion 33a of a corresponding one of the second flexible pipings 33A to 33L via a rotary joint 32. In other words, in each of the second flexible pipings 33A to 33L, one end portion 33a is connected to a corresponding one of the first pipings 31A to 31L via a rotary joint 32. According to the configuration with regard to the rotary joints 32, the rotary joints 32 tolerate relative rotations of the respective second flexible pipings 33A to 33L and corresponding first pipings 31A to 31L.

The rotary joints 32 are attached to the respective second flexible pipings 33A to 33L. Each rotary joint 32 is a columnar pipe member extending parallel to the axial direction S1. Each rotary joint 32 is configured so that one end portion 32a and the other end portion 32b of the rotary joint 32 can rotate relative to each other around a central axis of the rotary joint 32.

In the present embodiment, an outer diameter of each rotary joint 32 is set to a small value being approximately twice the outer diameter of each of the second flexible pipings 33A to 33L. Each rotary joint 32 is adjacent to the side wall 6. One end portion 32a of each rotary joint 32 includes a male threaded portion. This male threaded portion is screwed and coupled to a fixing nut 39 provided at the other end portion of the corresponding third portion 38 of a corresponding one of the first pipings 31A to 31L. According to the configuration with regard to the rotary joint 32, each rotary joint 32 is connected to the other end portion of a corresponding third portion 38. Each third portion 38 is provided with a looseness preventive mechanism 40 to prevent the fixing nut 39 from loosening.

Referring to FIG. 5 and FIG. 9, the looseness preventive mechanism 40 includes a fixed flange portion 41 and a pair of receiving members 42 and 43.

The fixed flange portion 41 is adjacent to the side wall flange portion 14 in the present embodiment. The fixed flange portion 41 includes a pair of divided bodies 41a and 41b. The pair of divided bodies 41a and 41b are respectively formed into fan shapes with angles of 180 degrees, and face each other to form an annular flange. According to the configuration with regard to the fixed flange portion 41, after the rotary joint 32 is connected to the third portion 38, the fixed flange portion 41 can be fitted to an outer circumferential portion of the third portion 38. The pair of divided bodies 41a and 41b are fixed to each other by using a fixing member 41c such as a fixing screw. A pair of receiving members 42 and 43 extend from the fixed flange portion 41.

Each of the receiving members 42 and 43 is configured to be attachable to and removable from the fixed flange portion 41 by using a screw member. The receiving members 42 and 43 respectively have planar tip end portions extending parallel to the axial direction S1. A tip end portion of one receiving member 42 is in surface contact with a planar portion formed on an outer circumferential portion of one end portion 32a of the rotary joint 32. The other receiving member 43 is in surface contact with a planar portion of an outer circumferential portion of the fixing nut 39. According to the configuration with regard to the rotary joint 32, the one end portion 32a of each rotary joint 32 and a corresponding fixing nut 39 are restrained from rotating relative to each other, and accordingly, each fixing nut 39 is prevented from loosening.

Referring to FIG. 4, FIG. 5, FIG. 7, and FIG. 8, the other end portion 32b of each rotary joint 32 is connected to one end portion 33a of a corresponding one of the second flexible pipings 33A to 33L, and fixed to this one end portion 33a.

The second flexible pipings 33A to 33L are disposed to surround the rotary support part 10, and extend almost along the axial direction S1.

Each of the second flexible pipings 33A to 33L is disposed between the beam portion 25 and the base portion 23 of the mount 21 in the up-down direction. In detail, in the present embodiment, in a side view, in a space surrounded by the base portion 23, the columnar support 24, and the beam portion 25 of the mount 21 and the side wall 6 of the housing chamber 2, the rotary joints 32, the second flexible pipings 33A to 33L, the folded-back pipings 34A to 34L, the linear guide 15, the third flexible pipings 35A to 35L, the chambers 16 and 17, parts of the gas supply pipes 18 and 19, and a part of the main rotation mechanism 20, are housed.

Outer diameters of the respective second flexible pipings 33A to 33L are set to values slightly larger than outer diameters of the third portions 38 of the respective first pipings 31A to 31L, that is, set to small values. According to the configuration with regard to the second flexible pipings 33A to 33L, tolerances of bending deformations of the respective second flexible pipings 33A to 33L are set to be large.

Each of the second flexible pipings 33A to 33L is formed of a flexible pipe with flexibility. Each of the second flexible pipings 33A to 33L is bending-deformable and torsionally deformable. Concerning each of the second flexible pipings 33A to 33L, a tolerance of bending deformation is larger than a tolerance of torsional deformation. With the configuration described above with regard to the second flexible pipings 33A to 33L, even if relative positions of the third portions 38 of the respective first pipings 31A to 31L and corresponding folded-back pipings 34A to 34L are not accurately set, each of the second flexible pipings 33A to 33L can reliably connect a corresponding one of the first pipings 31A to 31L and a corresponding one of the folded-back pipings 34A to 34L.

One end portion 33a of each of the second flexible pipings 33A to 33L is fixed to the other end portion 32b of a corresponding rotary joint 32 by using a nut, etc. With the configuration described above with regard to the second flexible pipings 33A to 33L, one end portion 33a of each of the second flexible pipings 33A to 33L is configured to rotate in conjunction with (in the present embodiment, rotate integrally with) a corresponding one of the first pipings 31A to 31L around the rotation axis L1, and is connected to the third portion 38 of a corresponding one of the first pipings 31A to 31L via a corresponding rotary joint 32. The other end portion 33b of each of the second flexible pipings 33A to 33L is fixed to one end portion of a corresponding one of the folded-back pipings 34A to 34L by using a nut, etc., and connected to this one end portion.

Each of the folded-back pipings 34A to 34L is provided as a piping that extends away from a corresponding one of the second flexible pipings 33A to 33L toward one side in the axial direction S1, and then extends away from the rotary support part 10, and thereafter, faces the other side in the axial direction S1 (faces the side wall 6 side of the housing chamber 2). Thus, by using the folded-back pipings 34A to 33L, the respective pipelines 13A to 13L can be disposed at high accumulation in a limited space. The respective folded-back pipings 34A to 34L are disposed on the columnar support 24 side of the mount 21 in the present embodiment.

Each of the folded-back pipings 34A to 34L includes a first portion 45, a second portion 46, and a valve 47 provided at the second portion 46.

The first portion 45 of each of the folded-back pipings 34A to 34L is provided as a portion extending away from a corresponding one of the second flexible pipings 33A to 33L along the axial direction S1. One end portion of each first portion 45 is connected to the other end portion 33b of a corresponding one of the second flexible pipings 33A to 33L, and fixed to the other end portion 33b. In each of the folded-back pipings 34A to 34L, the first portion 45 is connected to the second portion 46 via a 90° elbow.

This first portion 45, that is, each of the folded-back pipings 34A to 34L is configured to be linearly movable in a direction parallel to the axial direction S1 by the linear guide 15. A movable guide portion 51 of the linear guide 15 supports the other end portions 33b of the respective second flexible pipings 33A to 33L via the folded-back pipings 34A to 34L. The linear guide 15 supports the folded-back pipings 34A to 34L and the other end portions 33b of the second flexible pipings 33A to 33L.

The linear guide 15 includes the movable guide portion 51 and a fixed guide portion 52.

The movable guide portion 51 is configured to be linearly movable in a direction parallel to the axial direction S1 in accordance with deforming movements (in the present embodiment, bending movements) of the second flexible pipings 33A to 33L caused by rotations of the first pipings 31A to 31L around the rotation axis L1. The movable guide portion 51 is formed by using, for example, a sheet metal member. The movable guide portion 51 includes a first portion 51a, a second portion 51b, and a third portion 51c.

The first portion 51a is formed to have a rectangular tabular shape orthogonal to the axial direction S1. In the first portion 51a, a plurality of through hole portions are formed. Each through hole portion is penetrated through the first portion 45 of a corresponding one of the folded-back pipings 34A to 34L, and supports this first portion 45. The first portion 51a is fixed to the second portion 51b by using a bolt, etc.

The second portion 51b of the movable guide portion 51 is disposed at one side surface side of the first portion 51 facing the columnar support 24 side. This second portion 51b includes a columnar portion extending in the vertical direction. A lower end portion of the second portion 51b is fixed to the third portions 51c.

The third portions 51c of the movable guide portion 51 are portions extending parallel to the axial direction S1. A pair of third portions 51c are provided at the left and right sides in a front view shown in FIG. 8. On a lower surface of each third portion 51c, a recessed line portion extending along the axial direction S1 is formed. This third portion 51c is received by the fixed guide portion 52.

The fixed guide portion 52 includes a pair of rails 52a and 52a disposed at the left and right sides in the front view shown in FIG. 8. Each rail 52a is a projecting portion extending parallel to the axial direction S1, and supports a corresponding third portion 51c of the movable guide portion 51 movably in the axial direction S1. Each of the rails 52a and 52a receives a corresponding one of the movable guide portions 51c and 51c slidably. According to the configuration with regard to the fixed guide portion 52, the movable guide portion 51 is slidable in the axial direction S1 with respect to the fixed guide portion 52. The fixed guide portion 52 is fixed to the support member 53 disposed above the base portion 23 of the mount 21, and is supported by this support member 53.

The second portion 46 of each of the folded-back pipings 34A to 34L is provided as a portion extending away from the rotary support part 10. One end portion of each second portion 46 is connected to a corresponding first portion 45. In the front view shown in FIG. 8, the folded-back pipings 34A to 34L are arranged around the rotation axis L1. In the front view, each of the second portions 46 of the folded-back pipings 34A to 34E as pipings for the nozzle unit 11 for a thick tank extends from a corresponding first portion 45 toward a left side of a virtual vertical plane V1 that includes the rotation axis L1 of the rotary support part 10 and extends vertically. In the present embodiment, each of the second portions 46 of the folded-back pipings 34A and 34B extends toward the upper left side in the front view from a corresponding first portion 45. The second portion 46 of the folded-back piping 34C extends substantially horizontally leftward in the front view from a corresponding first portion 45. Each of the second portions 46 of the folded-back pipings 34D and 34E extends toward the lower left side in the front view from a corresponding first portion 45.

In the front view, the second portions 46 of the folded-back pipings 34F to 34L as pipings for the nozzle unit 12 for a thin tank, extend from corresponding first portions 45 toward the right side of the vertical plane V1. In the present embodiment, the second portions 46 of the folded-back pipings 34F to 34H extend toward the upper right side in the front view from corresponding first portions 45. The second portion 46 of the folded-back piping 341 extends substantially horizontally rightward in the front view from a corresponding first portion 45. The second portions 46 of the folded-back pipings 34J to 34L extend toward the lower right side in the front view from corresponding first portions 45.

At an intermediate portion of the second portion 46 of each of the folded-back pipings 34A to 34L, a valve 47 is provided. Each valve 47 is, for example, a manually opening and closing fluid regulation valve, and configured to adjust a flow rate of a compressed gas in a corresponding one of the pipelines 13A to 13L in a range between zero and a predetermined value. The respective valves 47 are disposed around the rotary support part 10 so as not to come into contact with adjacent valves 47. A handle provided on each valve 47 is disposed at a position advanced from the second portion 46 to the columnar support 24 side along the axial direction S1. The other end portion of the second portion of each of the folded-back pipings 34A to 34L is provided with a 90° elbow 55, and an opening of the other end portion defined by the 90° elbow 55 faces the housing chamber 2 side along the axial direction S1. The 90° elbow 55 at the other end portion of each of the second portions 46 is connected to one end portion 35a of a corresponding one of the third flexible pipings 35A to 35L.

In the present embodiment, each of the third flexible pipings 35A to 35L is disposed in a U shape. The third flexible pipings 35A to 35L extend from the elbows 55 as the other end portions of corresponding folded-back pipings 34A to 34L toward the housing chamber 2 side, and then extend downward, and thereafter, extend away from the housing chamber 2. In other words, the third flexible pipings 35A to 35L extend toward the first piping 31A to 31L sides, and then extend downward, and thereafter, extend away from the first pipings 31A to 31L. Thus, the third flexible pipings 35A to 35L include portions extending in curved forms toward the lower side of the rotary support part 10.

Each of the third flexible pipings 35A to 35L is formed by using a flexible pipe with flexibility, and is bending-deformable and torsionally deformable. Concerning each of the third flexible pipings 35A to 35L, a tolerance of bending deformation is larger than a tolerance of torsional deformation. According to the configuration with regard to the third flexible pipings 35A to 35L, even if relative positions of the respective folded-back pipings 34A to 34L and corresponding chambers 16 and 17 are not accurately set, each of the third flexible pipings 35A to 35L can reliably connect a corresponding one of the folded-back pipings 34A to 34L and a corresponding chamber 16 or 17.

One end portion 35a and the other end portion 35b of each of the third flexible pipings 35A to 35L in a longitudinal direction of each of the third flexible pipings 35A to 35L are disposed at one end side in the axial direction S1 of the heat treatment apparatus 1. The other end side portion in the axial direction S1 of each of the third flexible pipings 35A to 35L extends in a curved form projecting toward the housing chamber 2. One end portion 35a of each of the third flexible pipings 35A to 35L is connected to the other end portion 33b of a corresponding one of the second flexible pipings 33A to 33L via a corresponding one of the folded-back pipings 34A to 34L, and is linearly movable integrally with the other end portion 33b. The other end portion 35b of each of the third flexible pipings 35A to 35L is connected to a corresponding chamber 16 or 17.

The chamber 16 is provided to distribute a compressed gas supplied from the gas supply pipe 18 to the respective pipelines 13A to 13E of the nozzle unit 11 for a thick tank. The chamber 17 is provided to distribute a compressed gas supplied from the gas supply pipe 19 to the respective pipelines 13F to 13L of the nozzle unit 12 for a thin tank.

Each of the chambers 16 and 17 is an example of the “support portion” in the present invention, and the chambers 16 and 17 are configured to support the other end portions 35b of the respective third flexible pipings 35A to 35L. The respective chambers 16 and 17 are disposed below the rotary support part 10. In detail, the respective chambers 16 and 17 are fixed to the seating portion 56 provided on the base portion 23 of the mount 21. The respective chambers 16 and 17 are formed into hollow box shapes, and in the present embodiment, formed into hollow quadrangular prism shapes. When the heat treatment apparatus 1 is viewed from the front, the chamber 16 is disposed on the left side of the mount 21, and the chamber 17 is disposed on the right side of the mount 21.

On one side surface of the chamber 16 facing the housing chamber 2 side, a plurality of ports 57 are formed. To these ports 57, the other end portions 35b of corresponding third flexible pipings 35A to 35E are respectively connected.

One end portion of the gas supply pipe 18 is connected to, for example, an upper side surface of the chamber 16. The gas supply pipe 18 is connected to a compressed gas supply source not shown that includes a tank and a compressor, etc. On one side surface of the chamber 17 facing the housing chamber 2 side, a plurality of ports 58 are formed. To these ports 58, the other end portions 35b of corresponding third flexible pipings 35F to 35L are respectively connected. One end portion of the gas supply pipe 19 is connected to, for example, an upper side surface of the chamber 17. The gas supply pipe 19 is connected to a compressed gas supply source not shown that includes a tank and a compressor, etc.

At a position adjacent to the chambers 16 and 17 configured as described above, the main rotation mechanism 20 is disposed. The main rotation mechanism 20 is provided to rotate the rotary support part 10 around the central axis L1 of the rotary support part 10.

The main rotation mechanism 20 includes an electric motor 59 as a drive source, and a chain 60 as a power transmission member to transmit an output of the electric motor 59.

The electric motor 59 is disposed on the base portion 23 below the chambers 16 and 17. A rotation axis of the electric motor 59 extends parallel to the axial direction S1. The chain 60 is wound around a sprocket 70 coupled integrally rotatably to an output shaft of the electric motor 59 and a sprocket 71 coupled to a portion of the rotary support part 10 near the columnar support 24 integrally rotatably with the rotary support part 10. Both end portions of the rotary support part 10 to be driven to rotate by the main rotation mechanism 20 are supported by the pair of columnar supports 22 and 24 as described above. On the other hand, an intermediate portion of the rotary support part 10 is supported by the support mechanism 61.

Referring to FIG. 4 and FIG. 5, the support mechanism 61 is provided to rotatably support the intermediate portion of the rotary support part 10 in the axial direction S1. In the present embodiment, the support mechanism 61 supports, in the rotary support part 10, a portion that passes through the through hole portion 6a of the side wall 6 of the housing chamber 2. In the present embodiment, the support mechanism 61 supports the intermediate portion of the rotary support part 10 via the side wall flange portion 14 so as to lift-up the side wall flange portion 14.

The support mechanism 61 includes a roller 62 configured to have a cylindrical shell member formed outside a bearing, a bracket 63 supporting the roller 62, and a bolt 64 as a joint member to join the roller 62 and the bracket 63.

The roller 62 is in rolling contact with a lower end portion of an outer circumferential surface 14a of the side wall flange portion 14. A central axis of the roller 62 extends parallel to the axial direction S1. In the present embodiment, the roller 62 includes a rolling bearing. In the present embodiment, a mode in which one roller 62 is provided is described by way of example, however, it is also possible that a plurality of rollers 62 are provided. In the present embodiment, the roller 62 receives one end portion of the side wall flange portion 14 in the axial direction S1. This roller 62 is rotatably supported on an upper portion 63a of the bracket 63 by a bolt 64.

The bolt 64 penetrates through the upper portion 63a of the bracket 63, and is inserted into a central hole portion of the roller 62. The bracket 63 is formed by using, for example, a sheet metal member. In the present embodiment, the bracket 63 is formed into a crank shape in a side view. The upper portion 63a of the bracket 63 extends vertically.

The intermediate portion 63b of the bracket 63 extends horizontally. A lower portion 63c of the bracket 63 extends vertically. In this lower portion 63c, a vertically long hole 63d is formed. Into this vertically long hole 63d, a bolt 65 is inserted. This bolt 65 is screwed and coupled to a female threaded portion formed on the side wall 6 of the housing chamber 2, and fixes the bracket 63 to this side wall 6. With the above-described configuration, the position of the vertically long hole 63d of the bracket 63 with respect to the bolt 65 can be adjusted. That is, through positional changes of the bracket 63 and the roller 62 in the vertical direction, the position of the rotary support part 10 can be adjusted. A position adjusting mechanism 67 capable of adjusting the position of the support mechanism 61 is provided to adjust the position of the rotary support part 10.

The position adjusting mechanism 67 includes a bracket 68 and an adjusting bolt 69.

The bracket 68 is, for example, an L-shaped sheet metal member. In the bracket 68, a portion extending in the vertical direction is fixed to the side wall 6 of the housing chamber 2 by the bolt 65. In the bracket 68, a nut 68a is fixed to a portion extending in the horizontal direction, and a through hole portion continuous with a female threaded portion of the nut 68a is formed. The adjusting bolt 69 penetrates through this through hole portion of the bracket 68 and is screwed and coupled to the nut 68a, and held by the nut 68a.

The adjusting bolt 69 is disposed below the intermediate portion 63b of the bracket 63. An upper end portion of the adjusting bolt 69 receives the intermediate portion 63b of the bracket 63. By adjusting a vertical position of the adjusting bolt 69 with respect to the bracket 63, positions of the bracket 63, the roller 62, the side wall flange portion 14, and the intermediate portion of the rotary support part 10 in the vertical direction can be adjusted.

The heat treatment apparatus 1 is schematically configured as described above. Next, an example of operation in the heat treatment apparatus 1 is described.

As shown in FIG. 2 and FIG. 4, in the heat treatment apparatus 1, when heat treatment is applied to the thick tank 101, members such as the rotary support part 10, etc., are disposed at the first position P1. At this time, the second flexible pipings 33A to 33L extend substantially parallel to the axial direction S1. On the other hand, as shown in FIG. 3, FIG. 10, and FIG. 11, when heat treatment is applied to the thin tank 102, the rotary support part 10 rotates from the first position P1 to the second position P2 in response to operation of the main rotation mechanism 20.

When the rotary support part 10 rotates from the first position P1 to the second position P2, the first pipings 31A to 31L, the respective rotary joints 32, and one end portions 33a of the respective second flexible pipings 33A to 33L of the respective pipelines 13A to 13L rotate from the first position P1 to the second position P2 integrally with the rotary support part 10. Along with this, the position of the one end portion 33a and the position of the other end portion 33b of each of the second flexible pipings 33A to 33L around the rotation axis L1 deviate from each other. As a result, each of the second flexible pipings 33A to 33L is bent as shown in FIG. 10, and accordingly, its entire length in the axial direction S1 becomes shorter. That is, the distance between the one end portion 33a and the other end portion 33b in the axial direction S1 becomes shorter.

At this time, the other end portions 33b of the respective second flexible pipings 33A to 33L, the respective folded-back pipings 34A to 34L, the movable guide portion 51, and the one end portions 35a of the respective third flexible pipings 35A to 35L are linearly displaced to the first piping 31A to 31L sides along the axial direction S1. At this time, since the respective third flexible pipings 35A to 35L have flexibility, these flexibly deform, and the intermediate portions of the respective third flexible pipings 35A to 35L are displaced to the housing chamber 2 side.

Then, in a case where heat treatment is applied to the thick tank 101 again, the rotary support part 10 is returned from the second position P2 to the first position P1 shown in FIG. 2 and FIG. 4. Then, the other end portions 33b of the respective second flexible pipings 33A to 33L, etc., are also returned to the positions that are in the case of applying heat treatment to the thin tank 102.

As described above, according to the present embodiment, along with rotational movements of the rotary support part 10 of the rotary support part 10 and the respective nozzles 11A to 11C and 12F to 12J around the rotation axis L1, one end portions 33a of the respective second flexible pipings 33A to 33L rotate around the rotation axis L1. Due to such movements, the other end portions 33b of the respective second flexible pipings 33A to 33L are subjected to a force to attract them toward one end portion 33a sides of the second flexible pipings 33A to 33L or a force in a direction away from the one end portions 33a. As a result, the respective second flexible pipings 33A to 33L bend and deform so that their lengths in the axial direction S1 become shorter or longer. Then, along with such deformations of the respective second flexible pipings 33A to 33L, the movable guide portion 51 of the linear guide 15 linearly moves. With this configuration, application of excessive loads between the one end portions 33a and the other end portions 33b of the second flexible pipings 33A to 33L rotating relative to each other around the rotation axis L1 according to rotational movements of the respective nozzles 11A to 11C and 12F to 12J can be suppressed. In addition, since the plurality of second flexible pipings 33A to 33L are provided, each of the second flexible pipings 33A to 33L can be made thinner. Accordingly, flexibility of the respective second flexible pipings 33A to 33L can be increased. As a result, in each of the second flexible pipings 33A to 33L, a tolerance of an amount of relative rotation between the one end portion 33a and the other end portion 33b around the rotation axis L1 can be increased. Accordingly, in the fluid supply device 5, loads to be applied to the respective pipelines 13A to 13L can be made smaller, and tolerable rotation amounts of the respective nozzles 11A to 11C and 12F to 12J around the rotation axis L1 can be made larger. This being the case, the fluid supply device 5 in which loads to be applied to the respective pipelines 13A to 13L can be made smaller while tolerable rotation amounts of the respective nozzles 11A to 11C and 12F to 12J around the rotation axis L1 are increased, can be realized.

According to the present embodiment, along with linear displacement of the movable guide portion 51, one end portions 35a of the respective third flexible pipings 35A to 35L are displaced relative to the other end portions 35b of the third flexible pipings 35A to 35L in a direction parallel to the axial direction S1. Such a displacement can reduce a load to be caused by bending deformation of the third flexible pipings 35A to 35L. Therefore, loads on the pipings in the fluid supply device 5 can be made smaller

According to the present embodiment, the chambers 16 and 17 as the support portion are disposed below the rotary support part 10, and at least parts of the third flexible pipings 35A to 35L extend in curved forms toward a lower side of the rotary support part 10. With this configuration, the chambers 16 and 17 are disposed in a space below the rotary support part 10. Thus, in a space produced by provision of the rotary support part 10, the chambers 16 and 17 and at least parts of the third flexible pipings 35A to 35L can be disposed. As a result, through effective utilization of the space, the fluid supply device 5 can be made more compact.

According to the present embodiment, the rotary joints 32 are configured to tolerate relative rotations of the respective second flexible pipings 33A to 33L and corresponding first pipings 33A to 33L. With this configuration, in the second flexible pipings 33A to 33L provided with the rotary joints 32, torsional movements between one end portions 33a and the other end portions 33b can be greatly suppressed. Accordingly, in each of the second flexible pipings 33A to 33L, a tolerance of relative rotation between one end portion 33a and the other end portion 33b around the rotation axis L1 can be increased. That is, tolerable rotation amounts of the respective nozzles 11A to 11C and 12F to 12J around the rotation axis L1 can be increased. In addition, loads to be applied to the respective second flexible pipings 33A to 33L can be reduced.

According to the present embodiment, in each of the pipelines 13A to 13L, the rotary joint 32 provided is one in number. Thus, the number of rotary joints 32 to be provided for each of the pipelines 13A to 13L is set to be minimum. As a result, the number of comparatively expensive rotary joints 32 to be used can be made small, so that the fluid supply device 5 can be formed more inexpensively.

According to the present embodiment, the rotary support part 10 subjected to a great load by supporting the plurality of nozzles 11A to 11C and 12F to 12J and the plurality of first pipings 31A to 31L is supported by the support mechanism 61. Accordingly, the rotary support part 10 can be more reliably prevented from deviating from an original position due to its rotational movement. In addition, since the position adjusting mechanism 67 is provided, the position of the rotary support part 10 with respect to the housing chamber 2, etc., in which the rotary support part 10 is installed can be adjusted.

Although an embodiment of the present invention is described above, the present invention is not limited to the embodiment described above. Various modifications of the present invention are possible as long as these fall within the scope of claims.

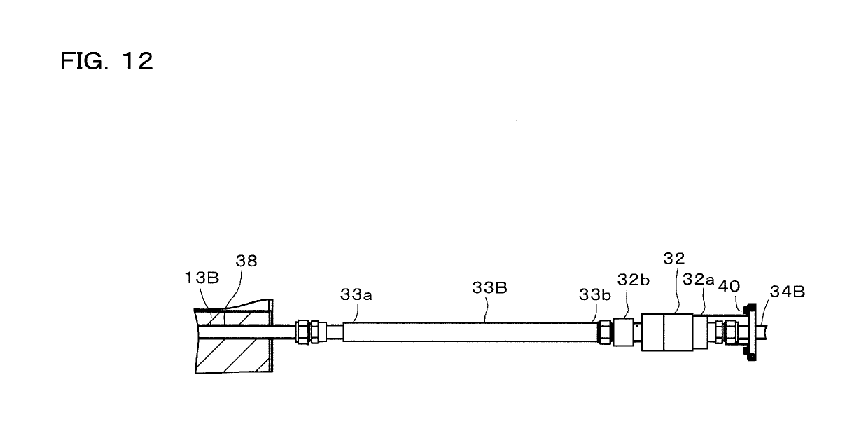

(1) In the above-described embodiment, a mode in which the rotary joints 32 are connected to one end portions 33a of the respective second flexible pipings 33A to 33L is described by way of example. However, other modes are also possible. For example, as shown in FIG. 12, rotary joints 32 may be disposed between the other end portions 33b of the respective second flexible pipings 33A to 33L and one end portions of corresponding folded-back pipings 34A to 34L. In this case, one end portions 33a are connected to the third portions 38 of corresponding first pipings 13A to 13L without interposition of the rotary joints 32. The rotary joints 32 are configured to tolerate relative rotations of corresponding second flexible pipings 33A to 33L and corresponding third flexible pipings 35A to 35L.

In FIG. 12, one second flexible piping 33B among the second flexible pipings 33A to 33L is illustrated. Each of the second flexible pipings 33A to 33L is connected to one end portion of a corresponding one of the third flexible pipings 35A to 35L via a corresponding one of the folded-back pipings 34A to 34L. In this embodiment, torsional movements of the second flexible pipings 33A to 33L can be suppressed by relative rotations between the one end portions 32a and the other end portions 32b of the rotary joints 32 according to rotation of the rotary support part 10.

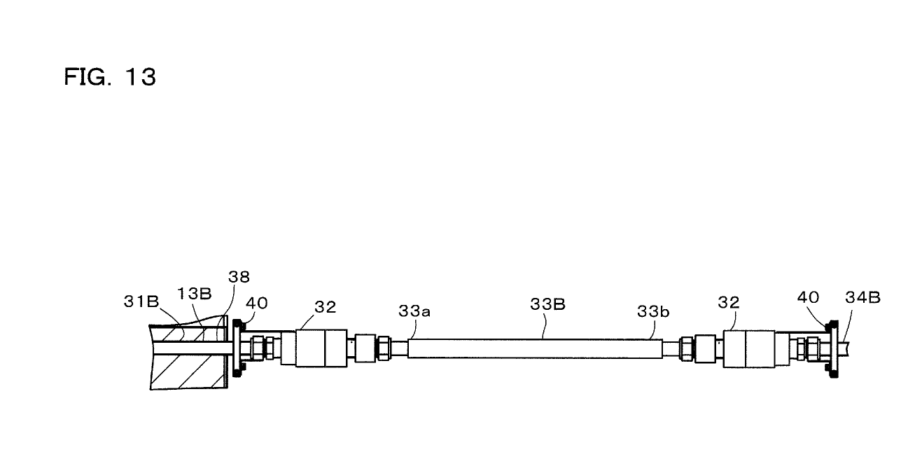

(2) It is also possible that, as shown in FIG. 13, at both of one end portion 33a and the other end portion 33b of each of the second flexible pipings 33A to 33L, rotary joints 32 are provided. In this case, one end portion 33a of each of the second flexible pipings 33A to 33L is connected to a corresponding one of the first pipings 31A to 31L via a corresponding rotary joint 32. The other end portion 33b of each of the second flexible pipings 33A to 33L is connected to a corresponding one of the third flexible pipings 35A to 35L via a corresponding rotary joint 32 and a corresponding one of the folded-back pipings 34A to 34L.

(3) In the above-described embodiment, a mode in which the fluid supply device 5 supplies a gas is described by way of example. However, other modes are also possible. For example, the fluid supply device may be a device to supply a liquid such as water.

(4) In the above-described embodiment, a mode in which each of the second flexible pipings 33A to 33L and a corresponding one of the third flexible pipings 35A to 35L are connected via a corresponding one of the folded-back pipings 34A to 34L is described by way of example. However, other modes are also possible. For example, each of the second flexible pipings 33A to 33L may be directly connected to a corresponding one of the third flexible pipings 35A to 35L.

In the above-described embodiment, a mode in which a shaft-shaped member is used as the rotary support part 10 to support the nozzles 11A to 11C and 12F to 12J and the first pipings 31A to 31L is described by way of example. However, other modes are also possible. The rotary support part is not limited to the shaft-shaped member as long as the rotary support part is configured to support the nozzles and the first pipings rotatably around the rotation axis L1.

(6) In the above-described embodiment, a mode in which the movable guide portion 51 supports the other end portions 33b of the second flexible pipings 33A to 33L via the folded-back pipings 34A to 34L is described by way of example. However, other modes are also possible. For example, the movable guide portion 51 may directly support the other end portions 33b of the second flexible pipings 33A to 33L.

(7) In the above-described embodiment, the fluid supply device is required to include a plurality of nozzles, a plurality of first pipings, a rotary support part, a plurality of second flexible pipings, and a linear guide, and other components may be provided so that the number of the other components are one or more, or may not be provided.

### INDUSTRIAL APPLICABILITY

The present invention can be widely applied as a fluid supply device.

### DESCRIPTION OF SYMBOLS

5: Fluid supply device
10: Rotary support part
11A, 11B, 11C, 12F, 12G, 12H, 12I, 12J: Nozzle
15: Linear guide
16, 17: Chamber (support portion)
31A-31L: First piping
32: Rotary joint
33A-33L: Second flexible piping
33a: One end portion of second flexible piping
33b: Other end portion of second flexible piping
35A-35L: Third flexible piping
35a: One end portion of third flexible piping
35b: Other end portion of third flexible piping
51: Movable guide portion
61: Support mechanism
67: Position adjusting mechanism
L1: Rotation axis

1. A fluid supply device comprising:
a plurality of nozzles;
a plurality of first pipings connected to the plurality of nozzles;
a rotary support part to support the respective nozzles and the respective first pipings rotatably around a predetermined rotation axis;
a plurality of second flexible pipings cofigured to have flexibility, each including one end portion configured rotatably around the rotation axis in conjunction with a corresponding one of the plurality of first pipings, and configured to be connected to a corresponding one of the plurality of first pipings; and
a linear guide including a movable guide portion supporting the other end portions of the respective second flexible pipings, and linearly displaceable according to deforming movements of the respective second flexible pipings caused by rotations of the respective first pipings.

2. The fluid supply device according to claim 1, further comprising:
a plurality of third flexible pipings configured to have flexibility, each including one end portion connected to the other end portion of a corresponding one of the plurality of second flexible pipings and linearly displaceable integrally with the other end portion; and
a support portion to support other end portions of the plurality of third flexible pipings.

3. The fluid supply device according to claim 2, wherein
the support portion is disposed below the rotary support part; and
at least a part of each third flexible piping extends in a curved form toward a lower side of the rotary support part.

4. The fluid supply device according to claim 1, wherein
at least one of one end portion and the other end portion of the second flexible piping is connected to a corresponding one of the first pipings and a corresponding one of the third flexible pipings via a rotary joint, and
the rotary joint is configured to tolerate relative rotation of the second flexible piping and the corresponding first piping and third flexible piping.

5. The fluid supply device according to claim 1, further comprising:
a support mechanism to support the rotary support part; and
a position adjusting mechanism capable of adjusting a position of the support mechanism to adjust a position of the rotary support part.
